(19) United States
(12) Patent Application Publication
(10) Pub. No.: US 2022/0278560 A1
(43) Pub. Date: Sep. 1, 2022

(54) VEHICLE

(71) Applicant: TOYOTA JIDOSHA KABUSHIKI KAISHA, Aichi-ken (JP)

(72) Inventor: Hideyuki SAKURAI, Toyota-shi (JP)

(21) Appl. No.: 17/585,558

(22) Filed: Jan. 27, 2022

(30) Foreign Application Priority Data
Feb. 26, 2021 (JP) 2021-030898

(51) Int. Cl. H02J 50/23

(52) U.S. Cl. CPC H02J 50/23

(57) ABSTRACT

A vehicle includes: a transmission unit provided in a vehicle cabin to transmit a radio wave for supplying power to a device in the vehicle cabin; and a reflection unit that reflects the radio wave transmitted from the transmission unit toward the device. The reflection unit is provided on a skeleton member made of metal. The skeleton member including the reflection unit is covered from the vehicle cabin inner side by an interior member made of a material that allows passage of the radio wave.

### CROSS-REFERENCE TO RELATED APPLICATION

This application claims priority to Japanese Patent Application No. 2021-030898 filed on Feb. 26, 2021, incorporated herein by reference in its entirety.

### BACKGROUND

### 1. Technical Field

The present disclosure relates to a vehicle.

### 2. Description of Related Art

WO 2017/106816 discloses a vehicle that includes a wireless power supply system that supplies power to devices in the vehicle cabin using microwaves. The wireless power supply system is configured to reflect microwaves using a reflection body provided on a surface of a seat, a floor, a roof, etc. in the vehicle cabin and propagate the microwaves to electric devices to be supplied with power.

### SUMMARY

In the technology described in WO 2017/106816, however, a reflection unit is formed by providing a metal mesh or screen on a surface of a seat etc. in the vehicle cabin, and therefore a reflection body is exposed in the vehicle cabin. Thus, there is room for improvement to maintain good design in the vehicle cabin in the above related art.

The present disclosure enables power supply to electric devices while maintaining an aesthetic appearance in the vehicle cabin, in a vehicle in which radio waves for power supply are propagated using a reflection unit provided in the vehicle cabin.

A vehicle according to an aspect of the present disclosure includes: a transmission unit provided in a vehicle cabin to transmit a radio wave for supplying power to a device in the vehicle cabin; and a reflection unit that reflects the radio wave transmitted from the transmission unit toward the device. The reflection unit is provided on a skeleton member made of metal. The skeleton member including the reflection unit is covered from the vehicle cabin inner side by an interior member made of a material that allows passage of the radio wave.

The vehicle according to the aspect of the present disclosure includes a transmission unit that transmits a radio wave for supplying power to a device in the vehicle cabin. The vehicle also includes a reflection unit provided in the cabin to reflect the transmitted radio wave toward the device. Consequently, the radio wave transmitted from the transmission unit can be reflected by the reflection unit to reach the device in the vehicle cabin to supply power to the device.

In the vehicle according to the aspect of the present disclosure, the reflection unit is provided on a skeleton member, which is made of metal, of the vehicle, and the skeleton member including the reflection unit is covered from the inner side of the vehicle cabin by an interior member made of a material that allows passage of the radio wave. Therefore, the radio wave can be reflected toward the device in the vehicle cabin without the reflection unit being exposed in the vehicle cabin. As a result, it is possible to supply power to an electric device in the vehicle cabin while maintaining an aesthetic appearance in the vehicle cabin.

In the vehicle according to the aspect of the present disclosure configured as described above, the skeleton member may be a pillar that extends in a vehicle up-down direction; and the reflection unit may be provided on a surface of the pillar on the vehicle cabin inner side.

In the vehicle according to the aspect of the present disclosure, the reflection unit may be provided on a surface of the pillar, which extends in the vehicle up-down direction, on the inner side of the vehicle cabin, and therefore the reflection unit can be covered by an interior member such as a pillar garnish. Consequently, it is possible to supply power to an electric device in the vehicle cabin while maintaining an aesthetic appearance in the vehicle cabin.

In the vehicle according to the aspect of the present disclosure, the skeleton member may be a roof cross member that extends in a vehicle width direction to reinforce a roof panel, and the reflection unit may be provided on a surface of the roof cross member on the vehicle cabin inner side.

In the vehicle according to the aspect of the present disclosure, the reflection unit may be provided on a surface of the roof cross member, which reinforces the roof panel, on the inner side of the vehicle cabin, and therefore the reflection unit can be covered by an interior member such as a roof head lining. Consequently, it is possible to supply power to an electric device in the vehicle cabin while maintaining an aesthetic appearance in the vehicle cabin.

In the vehicle according to the aspect of the present disclosure configured as described above, the skeleton member may be a floor cross member that extends in a vehicle width direction to reinforce a floor panel, and the reflection unit may be provided on a surface of the floor cross member on the vehicle cabin inner side.

In the vehicle according to the aspect of the present disclosure, the reflection unit may be provided on a surface of the floor cross member, which reinforces the floor panel, on the inner side of the vehicle cabin, and therefore the reflection unit can be covered by an interior member such as a floor carpet. Consequently, it is possible to supply power to an electric device in the vehicle cabin while maintaining an aesthetic appearance in the vehicle cabin.

The vehicle according to the aspect of the present disclosure configured as described above may further include a control unit that controls the radio wave transmitted from the transmission unit; wherein a plurality of reflection units may be provided as the reflection unit; and the control unit may include a select unit that selects at least one reflection unit that reflects the radio wave from the plurality of reflection units.

The vehicle according to the aspect of the present disclosure may be provided with a plurality of reflection units. The vehicle may include a control unit that controls the radio wave transmitted from the transmission unit. The control unit selects at least one reflection unit that reflects the transmitted radio wave from the plurality of reflection units. Consequently, a plurality of paths can be set to propagate the radio wave to a desired position, and therefore the radio wave can be effectively reflected toward the device to be supplied with power.

In the vehicle according to the aspect of the present disclosure configured as described above, the control unit may further include a device position identifying unit that identifies a position of the device in the vehicle cabin; and the select unit may select, based on the position identified by the device position identifying unit, at least one reflection unit that is able to reflect the radio wave toward the device installed at the position, from the plurality of reflection units.

In the vehicle according to the aspect of the present disclosure, the control unit may include a function of identifying the position of the device in the vehicle cabin, and may select at least one reflection unit that reflects the radio wave toward the position identified by the function from the plurality of reflection units. Consequently, it is possible to select the path for the radio wave in accordance with the position of the device in the vehicle cabin, and to efficiently reflect the radio wave toward the predetermined device.

In the vehicle according to the aspect of the present disclosure configured as described above, the control unit may further include an obstruction position identifying unit that identifies a position of an obstruction that obstructs propagation of the radio wave in the vehicle cabin; and the select unit may select, based on the position identified by the obstruction position identifying unit, at least one reflection unit that is able to propagate the radio wave while avoiding the obstruction that is present at the position, from the plurality of reflection units.

In the vehicle according to the aspect of the present disclosure, the control unit may include a function of identifying the position of an obstruction that obstructs propagation of the radio wave in the vehicle cabin, and may select at least one reflection unit that can propagate the radio wave while avoiding the position specified by the function. Consequently, it is possible to select the path for the radio wave in accordance with the position of an obstruction such as an occupant and a seat, and to efficiently reflect the radio wave toward the predetermined device.

In the vehicle according to the aspect of the present disclosure configured as described above, the reflection unit may include a recessed or protruding ridge line in a cross section taken in a direction that is orthogonal to a direction in which the skeleton member extends.

In the vehicle according to the aspect of the present disclosure, the reflection unit may include a recessed or protruding ridge line in a cross section taken in a direction that is orthogonal to the extending direction. Consequently, it is possible to enhance the rigidity of the skeleton member along with an increase in the second moment of area.

The vehicle according to the aspect of the present disclosure configured as described above may further include a reception unit provided in the vehicle cabin and connected to the device, the reception unit receiving the radio wave transmitted from the transmission unit; and the reflection unit may reflect the radio wave transmitted from the transmission unit toward the reception unit, and the reception unit may supply power to the device using the radio wave which the reception unit receives.

A reception unit that receives the radio wave transmitted from the transmission unit may be provided in the vehicle cabin of the vehicle according to the aspect of the present disclosure. The reception unit is connected to a device in the vehicle cabin, and can supply power to the device by receiving the radio wave reflected by the reflection unit. Consequently, it is possible to shorten wire harnesses connected to electrical components in the vehicle cabin, and to reduce the total number of required wire harnesses, compared to the conventional structure in which an in-vehicle battery and the electrical components are connected to each other by wire harnesses. As a result, the wiring space can be reduced, which improves the degree of freedom in designing the space in the vehicle cabin and increases the range of movement of the electrical components.

It is assumed to be difficult to directly supply power to an electrical component fixed to, or disposed in the vicinity of, a large metal member provided in the vehicle cabin, such as a seat frame, since the surrounding metal member reflects radio waves. By supplying power via the reception unit, however, power can be supplied efficiently without interference by the surrounding metal member.

As has been described above, the vehicle according to the aspect of the present disclosure has a good effect of supplying power to electric devices while maintaining an aesthetic appearance in the vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a vehicle according to the present embodiment;

FIG. 2 is a side view schematically illustrating the vehicle according to the present embodiment;

FIG. 3 is a perspective view illustrating a front portion in the vehicle cabin of the vehicle according to the present embodiment;

FIG. 4 is a cross-sectional view of a roof cross member, illustrating the cross section taken along the line IV-IV in FIG. 1;

FIG. 5 is a cross-sectional view of a pillar, illustrating the cross section taken along the line V-V in FIG. 2;

FIG. 6 is a sectional view of the pillar, illustrating the section taken along the line VI-VI in FIG. 2;

FIG. 7 is a sectional view of the pillar corresponding to FIG. 6, illustrating a reflection unit according to the present embodiment;

FIG. 8 illustrates a cross section of a floor cross member according to the present embodiment;

FIG. 9 is a block diagram illustrating an example of the hardware configuration of a control unit according to the present embodiment;

FIG. 10 is a block diagram illustrating the functional configuration of the control unit according to the present embodiment;

FIG. 11 is an example of a flowchart of a transmission process according to the present embodiment;

FIG. 12A illustrates an example of a path for radio waves transmitted from a transmission unit;

FIG. 12B illustrates another example of a path for radio waves transmitted from the transmission unit;

FIG. 13 illustrates an example of a path for radio waves transmitted from the transmitting unit; and

FIG. 14 is a sectional view of a pillar corresponding to FIG. 6, illustrating a reflection unit according to a modification of the present embodiment.

### DETAILED DESCRIPTION OF EMBODIMENTS

### First Embodiment

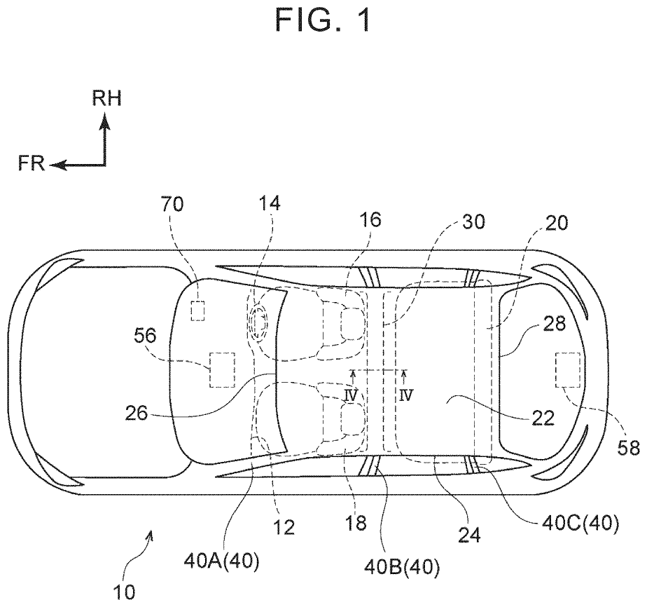

A vehicle 10 according to a first embodiment will be described below with reference to FIGS. 1 to 13. An arrow FR indicates the front side in the vehicle front-rear direction, an arrow UP indicates the upper side in the vehicle up-down direction, and an arrow RH indicates the right side in the vehicle width direction, which appear as appropriate in the drawings. When terms that indicate directions such as “front”, “rear”, “upper”, “lower”, “right”, and “left” are used in the following description, such terms should be understood to indicate front and rear in the vehicle front-rear direction, up and down in the vehicle up-down direction, and right and left as seen in the traveling direction of the vehicle, respectively, unless otherwise noted.

Skeleton Members of Vehicle

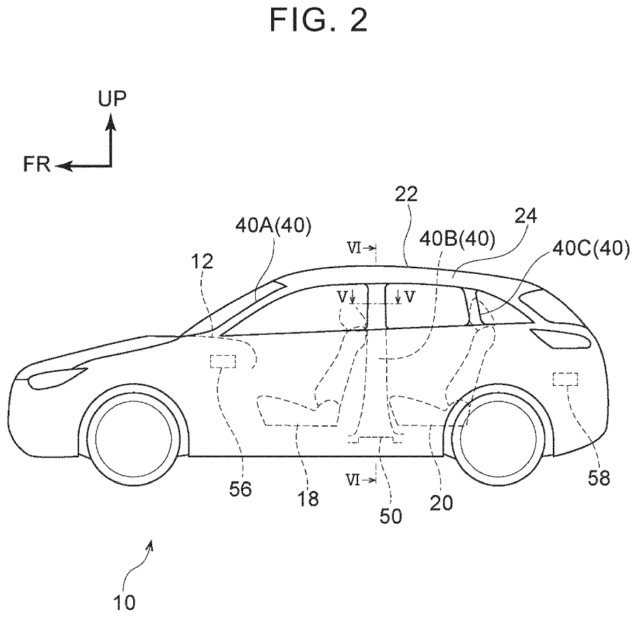

As illustrated in FIGS. 1 and 2, an instrument panel 12 made of a resin is provided at the front part in the vehicle cabin of the vehicle 10. The instrument panel 12 extends in the vehicle width direction. A steering wheel 14 is provided on the right side of the vehicle on the instrument panel 12. That is, in the present embodiment, the vehicle 10 is a right-hand drive vehicle in which the steering wheel 14 is provided on the right side and a seat 16 as a driver's seat is set on the right side of the vehicle, by way of example. Meanwhile, a seat 18 as a front passenger seat is set on the left side of the vehicle.

A seat 20 as a rear seat is set at the rear part in the vehicle cabin of the vehicle 10. The seat 20 is a three-seater seat, by way of example. Passengers can be seated on the right side and the left side and at the middle of the seat 20 in the vehicle width direction.

A roof panel 22 that constitutes a ceiling portion in the vehicle cabin of the vehicle 10 is constituted from a steel plate in a rectangular shape as viewed in a plan view. The roof panel 22 is reinforced by skeleton members made of metal, including a pair of roof side rails 24, a front header 26, a rear header 28, and a roof cross member 30.

The roof side rails 24 are formed in the shape of a beam that extends in the vehicle front-rear direction, and provided at an interval in the vehicle width direction. The respective front end portions of the roof side rails 24 are coupled to each other by the front header 26. The front header 26 is formed in the shape of a beam that extends in the vehicle width direction. The respective rear end portions of the roof side rails 24 are coupled to each other by the rear header 28. The rear header 28 is formed in the shape of a beam that extends in the vehicle width direction. The roof side rails 24, the front header 26, and the rear header 28 form a frame in a rectangular shape as viewed in a plan view, and reinforce the outer peripheral portion of the roof panel 22.

The roof panel 22 is also reinforced by a roof cross member 30 that crosslinks the roof side rails 24. The roof cross member 30 is formed in the shape of a beam that extends in the vehicle width direction. While one roof cross member 30 is illustrated in FIG. 1 for easier understanding, a plurality of roof cross members 30 is actually disposed at predetermined intervals in the vehicle front-rear direction.

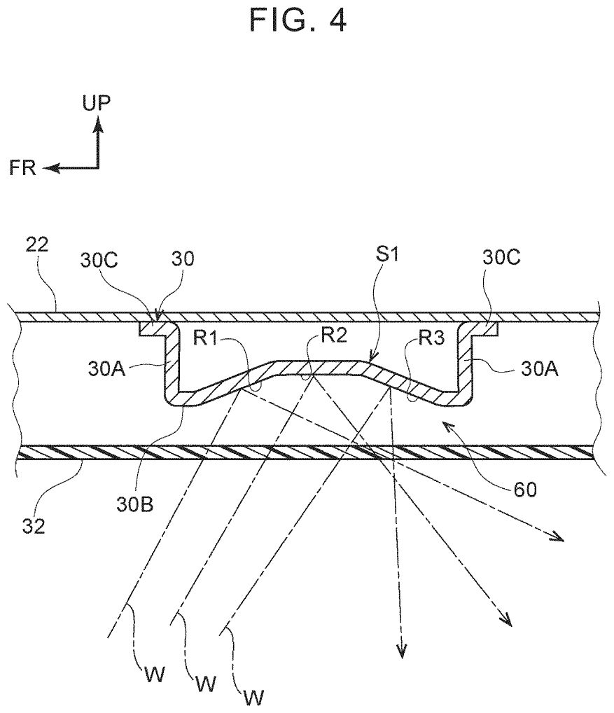

The roof side rails 24, the front header 26, the rear header 28, and the roof cross member 30 described above and reinforcing the roof panel 22 are covered by a roof head lining 32 (see FIG. 4) as an interior member from the inner side of the vehicle cabin. The roof head lining 32 is formed from a material that allows passage of radio waves such as microwaves. The roof head lining 32 includes a molded board made of a resin as a base material, and is formed by bonding a pad material formed from urethane etc. and a skin material to a surface of the molded board on the inner side of the vehicle cabin in layers, by way of example. The pad material and the skin material are not individually illustrated in FIG. 4.

The vehicle 10 includes a plurality of pillars 40 (40A to 40C) as skeleton members made of metal. The pillars 40 are each structured to have a closed cross section. A pair of front pillars 40A included in the pillars 40 is columnar members disposed respectively on the right side and the left side at the front part in the vehicle cabin, and extend in the vehicle up-down direction. The upper end portions of the front pillars 40A are respectively connected to the front end portions of the roof side rails 24 discussed above. The lower end portions of the front pillars 40A are respectively connected to the front end portions of a pair of rockers (not illustrated) that constitutes the skeleton members at the lower part of the vehicle. The rockers are beam-like members that extend in the vehicle front-rear direction, and are respectively disposed on the right and left sides at the lower part of the vehicle.

A pair of center pillars 40B included in the pillars 40 is respectively disposed on the right side and the left side at the middle in the vehicle cabin. The center pillars 40B are columnar members, and extend in the vehicle up-down direction. The upper end portions of the center pillars 40B are respectively connected to the middle portions of the roof side rails 24 in the vehicle front-rear direction. The lower end portions of the center pillars 40B are respectively connected to the middle portions of the rockers in the vehicle front-rear direction.

A pair of rear pillars 40C included in the pillars 40 is respectively disposed on the right side and the left side at the rear part in the vehicle cabin. The rear pillars 40C are columnar members, and extend in the vehicle up-down direction. The upper end portions of the rear pillars 40C are respectively connected to the rear end portions of the roof side rails 24. The lower end portions of the rear pillars 40C are respectively connected to the rear end portions of the rockers.

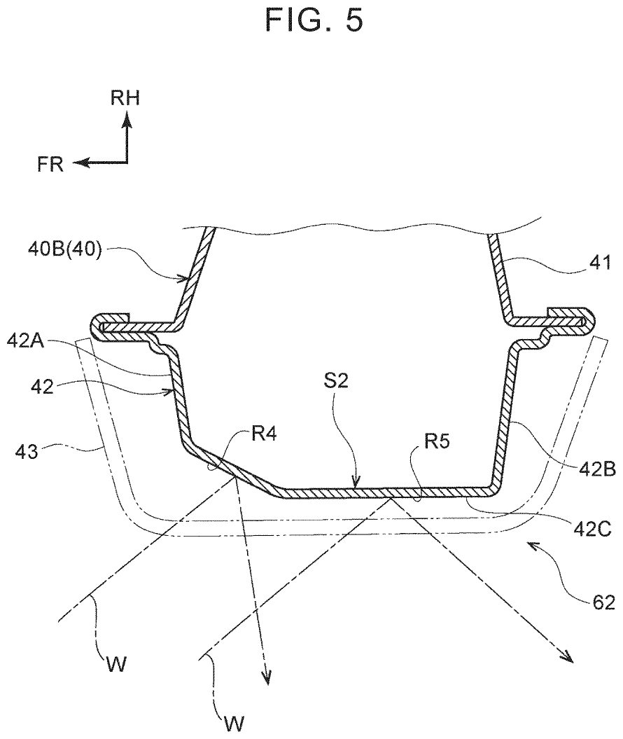

The pillars 40 (40A, 40B, 40C) which connect between the roof and the lower skeleton of the vehicle 10 in the up-down direction are covered by pillar garnishes 43 (see FIG. 5) as interior members from the inner side of the vehicle cabin. The pillar garnishes 43 are formed from a material that allows passage of radio waves such as microwaves, and is made of a resin, by way of example.

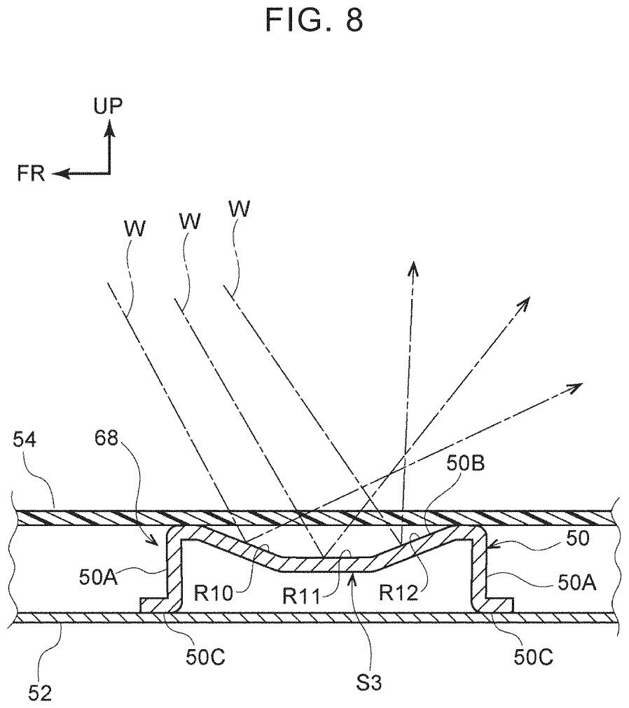

The vehicle 10 also includes a floor cross member 50 (see FIG. 2) as a skeleton member made of metal. The floor cross member 50 reinforces a floor panel 52 (see FIG. 8) that constitutes a floor portion in the vehicle cabin. The floor cross member 50 is formed in the shape of a beam that extends in the vehicle width direction, and crosslinks the rockers. While one floor cross member 50 is illustrated in FIG. 2 for easier understanding, a plurality of floor cross members 50 is actually disposed at predetermined intervals in the vehicle front-rear direction.

As illustrated in FIG. 8, the floor panel 52 and the floor cross member 50 are covered by a floor mat 54 as an interior member from the inner side of the vehicle cabin. The floor mat 54 is formed from a material that allows passage of radio waves such as microwaves, and is made of a resin, by way of example.

Various skeleton members of the vehicle 10 disposed in the vehicle cabin are covered by the interior members as described above so that surfaces of the skeleton members on the inner side of the vehicle cabin are not exposed in the vehicle cabin. Since the various interior members are formed from a material that allows passage of radio waves, on the other hand, radio waves transmitted toward the skeleton members pass through the interior members to be reflected by the skeleton members made of metal. Thus, a desired path may be set as the propagation path for radio waves by designing the skeleton members provided in the vehicle cabin of the vehicle 10 as a reflection surface for radio waves.

Conventionally, power is supplied to devices, which are electrical components in the vehicle cabin to be powered by electricity, by connecting a battery mounted on the vehicle 10 and the devices to each other through a wire harness. Such a wired power transmission method increases the amount of wire harnesses used, and increases wiring spaces, along with an increase in the number of devices mounted in the vehicle cabin. Thus, there has been devised a method of supplying power to various devices in the vehicle cabin by transmitting radio waves (e.g. microwaves) for supplying power to devices to be supplied with power. Such a wireless power supply method is referred to as “radio wave reception method”.

In the radio wave reception method, microwaves are transmitted from a transmitter provided in the vehicle cabin, and the transmitted microwaves are received by a reception unit of a device to be supplied with power. However, radio waves such as microwaves are absorbed through interference with an occupant, and thus may be obstructed by an occupant and not reach a desired position. In addition, radio waves such as microwaves are reflected to unexpected directions through interference with a seat frame etc. made of metal and provided in the vehicle cabin, and thus may not reach a desired position. Hence, it is necessary to propagate radio waves such as microwaves while avoiding an obstruction such as an occupant and a seat frame in the vehicle cabin, in order to reliably propagate the radio waves to a device that requires power supply.

In the present embodiment, the skeleton members made of metal and forming the outer shell of the vehicle cabin are provided with a plurality of reflection units 60, 62, 64, 68 so that radio waves transmitted from a transmission unit 56 reach a reception unit 58 by way of the reflection units 60, 62, 64, 68 as necessary. Consequently, the radio waves can be transmitted while avoiding an occupant, a seat frame, etc. in the vehicle cabin. The radio waves that have reached the reception unit 58 supply power to a device connected via the reception unit 58. Examples of the device connected to the reception unit 58 include electrical components provided in the vehicle cabin.

The vehicle 10 also includes a control unit 70 that controls radio waves transmitted from the transmission unit 56, and can transmit radio waves in a desired direction under control by the control unit 70. Consequently, a plurality of paths can be set as the transmission path for power, by selecting a predetermined reflection unit(s) from the reflection units 60, 62, 64, 68 and causing the selected reflection unit to reflect radio waves. Further, the control unit 70 identifies a device brought into the vehicle cabin, such as a smartphone or a tablet, as a device to be supplied with power. Thus, radio waves can be directly transmitted to the device in the vehicle cabin to supply power to the device. The details of the main portions of the present embodiment described above will be sequentially described below.

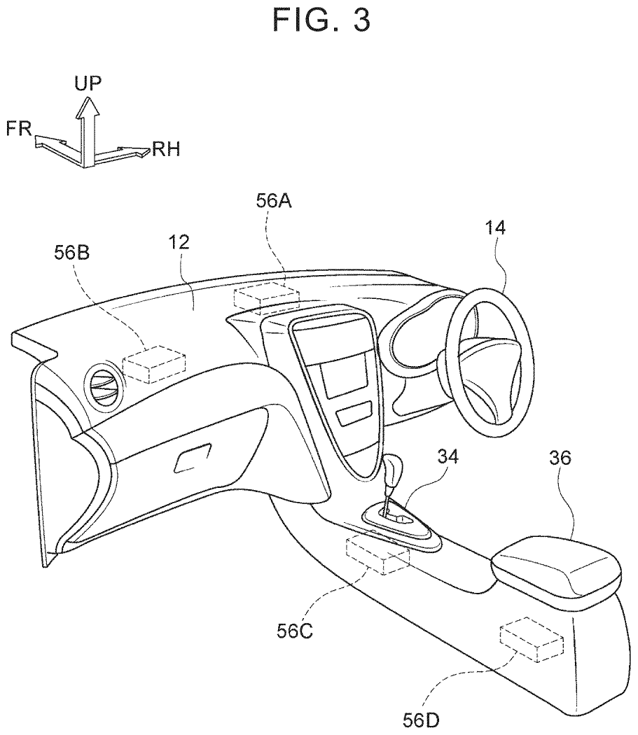

As illustrated in FIGS. 1 and 2, the transmission unit 56 according to the present embodiment is provided at the front part in the vehicle cabin, by way of example. In FIGS. 1 and 2, the transmission unit 56 is installed in a position at an inner side of the instrument panel 12. As illustrated in FIG. 3, however, the transmission unit 56 may be installed at a desired position in the vehicle cabin as necessary.

As illustrated in FIG. 3, a plurality of transmission units 56 (56A to 56D) may be provided. By way of example, the transmission unit 56A illustrated in FIG. 3 is disposed at the middle in the vehicle width direction and at the inner side of the instrument panel 12. The transmission unit 56A can transmit radio waves toward the center pillar 40B and/or the roof cross member 30 while avoiding the seat frames of the driver's seat and the front passenger seat (seats 16, 18) and the occupants. The transmission unit 56B is installed at the inner side of the instrument panel 12 on the front passenger seat side (one side in the vehicle width direction). The transmission unit 56B can transmit radio waves toward the center pillar 40B on the left side of the vehicle, the roof cross member 30, and the floor cross member 50 while avoiding the driver in the driver's seat. The transmission unit 56C is installed under a shift lever 34 provided between the driver's seat and the front passenger seat. The transmission unit 56C can transmit radio waves toward the roof cross member 30 and/or the floor cross member 50 through a space between the driver in the driver's seat and the passenger in the front passenger seat. The transmission unit 56D is disposed under a console box 36 provided between the driver's seat and the front passenger seat. The transmission unit 56D can transmit radio waves toward the roof cross member 30 and/or the floor cross member 50 in the vicinity of the rear seat without interference with the driver in the driver's seat and the passenger in the front passenger seat.

As illustrated in FIG. 3, a plurality of transmission units 56 may be provided at desired positions in the vehicle cabin. By way of example, the transmission unit 56A which is installed at the middle in the vehicle width direction and at the inner side of the instrument panel 12 and the transmission unit 56D which is installed under the console box 36 are mounted on the vehicle 10 according to the present embodiment. Radio waves transmitted from the transmission units 56A, 56D are received by the reception unit 58 which is provided in the vehicle cabin.

The reception unit 58 is provided in rear of the seat 20, by way of example. At least one of the electrical components (devices) provided in the vehicle cabin is connected to the reception unit 58 via a wire harness (not illustrated). Examples of the electrical components provided in the vehicle cabin include a seat reclining device, a seat sliding device, a side door, a power window, a foot light that illuminates the feet of an occupant, a ceiling light, and a buckle light that illuminates the buckle of a seatbelt. These electrical components are often fixed to a frame or a panel made of metal, or installed in the vicinity of such a frame or a panel. Therefore, if radio waves are directly transmitted to the electrical components, the radio waves may not easily reach the electrical components because of interference with the surrounding metal member. Therefore, power can be efficiently supplied while avoiding interference with the surrounding metal member by supplying power via the reception unit 58 as in the present embodiment.

The reflection units 60, 62, 64, 68 which are provided on the roof cross member 30, the pillar 40, and the floor cross member 50 will be described in detail below with reference to FIGS. 4 to 8. In the drawings, the path for radio waves W transmitted from the transmission unit 56 is schematically indicated by alternate long and short dash lines.

### Reflection Unit Provided on Roof Cross Member

FIG. 4 illustrates a cross section of the roof cross member 30, which extends in the vehicle width direction, taken in the vehicle front-rear direction which is orthogonal to the direction in which the roof cross member 30 extends. As illustrated in the drawing, the roof cross member 30 is a beam member that has a section in the shape of an inverted hat that opens upward of the vehicle. Specifically, the roof cross member 30 includes a pair of vertical wall portions 30A that face each other in the vehicle front-rear direction, a transverse wall portion 30B that connects between the respective lower end portions of the vertical wall portions 30A, and horizontal flange portions 30C that extend in directions away from each other from the respective upper end portions of the vertical wall portions 30A. The front and rear flange portions 30C of the roof cross member 30 are joined to the roof panel 22, and both end portions of the roof cross member 30 in the extending direction are connected to the respective roof side rails 24.

In the present embodiment, the reflection unit 60 is provided on the transverse wall portion 30B which constitutes a surface of the roof cross member 30 on the inner side of the vehicle cabin. The reflection unit 60 includes a plurality of reflection surfaces R formed on the inside surface of a recessed dent formed in the transverse wall portion 30B, and is formed integrally with the roof cross member 30. The reflection unit 60 according to the present embodiment is a dent in a generally trapezoidal shape including three reflection surfaces R1 to R3, by way of example, and includes a recessed ridge line S1 that is recessed upward of the vehicle in a cross section taken in the vehicle front-rear direction which is orthogonal to the direction of extension of the roof cross member 30. As a result, the second moment of area of the roof cross member 30 increases, which contributes to improving the flexural rigidity of the roof cross member 30.

The reflection surfaces R1 to R3 of the reflection unit 60 are directed to different directions, and the radio waves W reflected by the reflection unit 60 can be diffused in a plurality of (three) directions. For example, the reflection surface R1 reflects the radio waves W transmitted from the transmission unit 56 toward the reception unit 58 in rear of the seat 20. The reflection surface R2 reflects the radio waves W transmitted from the transmission unit 56 toward the height of a hand of a passenger seated in the seat 20. The reflection surface R3 reflects the radio waves W transmitted from the transmission unit 56 toward the floor cross member 50 directly therebelow. In this manner, the radio waves W transmitted from the transmission unit 56 can be diffused in a predetermined region at the rear part in the vehicle cabin when the radio waves W are radiated to a wide area of the reflection unit 60.

That is, when the radio waves W are to be received by a small mobile device, such as a smartphone, that is used by an occupant, it is occasionally difficult to reflect the radio waves W to the device with pinpoint accuracy. Since the reflection unit 60 can diffuse radio waves in a predetermined region, however, power can be supplied to a device that is moved in a small range or a small device.

When the transmitted radio waves W are highly directional, the radio waves W can be reflected in a predetermined direction by selecting a predetermined reflection surface(s) from the plurality of reflection surfaces. The reflection unit 60 configured as described above may be formed as a recessed reflection unit in which the transverse wall portion 30B of the roof cross member 30 is curved upward of the vehicle and which extends in the vehicle width direction. Alternatively, the reflection unit 60 may be formed at a plurality of locations along the direction of extension of the roof cross member 30.

### Reflection Unit Provided on Pillar

FIG. 5 illustrates a cross section of the center pillar 40B, which extends in the vehicle up-down direction, taken in the vehicle front-rear direction which is orthogonal to the direction in which the center pillar 40B extends. As illustrated in the drawing, the center pillar 40B includes a pillar outer 41 that has a hat-shaped section that opens to the inner side in the vehicle width direction and a pillar inner 42 that has a hat-shaped section that opens towards the outer side in the vehicle width direction. The center pillar 40B is a beam-like member that has a closed cross section formed by joining respective flange portions of the pillar inner 42 and the pillar outer 41 to each other in the vehicle width direction. The pillar inner 42 includes a front wall portion 42A and a rear wall portion 42B that face each other in the vehicle front-rear direction. The respective end portions of the front wall portion 42A and the rear wall portion 42B on the inner side in the vehicle width direction are connected to each other by a side wall portion 42C.

In the present embodiment, the entire side wall portion 42C (except for portions folded toward the pillar outer 41) that constitutes a surface of the center pillar 40B on the inner side of the vehicle cabin serves as the reflection unit 62. The reflection unit 62 includes a plurality of reflection surfaces R4 and R5 formed on the side wall portion 42C, and is formed integrally with the center pillar 40B. The reflection unit 62 (side wall portion 42C) according to the present embodiment is formed in a mountain shape that is protruding toward the inner side of the vehicle cabin by the two reflection surfaces R4 and R5, by way of example, and includes a protruding ridge line S2 that projects toward the inner side of the vehicle cabin in a sectional view in the vehicle front-rear direction which is orthogonal to the direction of extension of the center pillar 40B. As a result, the second moment of area of the center pillar 40B is increased, which contributes to improving the flexural rigidity of the center pillar 40B.

The reflection surfaces R4 and R5 of the reflection unit 62 are directed to different directions, and can diffuse the radio waves W reflected by the reflection unit 62 in a plurality of (two) directions. For example, the reflection surface R4 reflects the radio waves W transmitted from the transmission unit 56 toward the reflection unit 62 of the rear pillar 40C disposed on the other side in the vehicle width direction (left side in the vehicle width direction in FIG. 5). The reflection surface R5 reflects the radio waves W transmitted from the transmission unit 56 toward the reception unit 58 in rear of the seat 20. In this manner, the radio waves W transmitted from the transmission unit 56 can be diffused in a predetermined region at the rear part in the vehicle cabin when the radio waves W are radiated to a wide area of the reflection unit 62. When the transmitted radio waves W are highly directional, the radio waves W can be reflected in a predetermined direction by selecting a predetermined reflection surface(s) from the plurality of reflection surfaces.

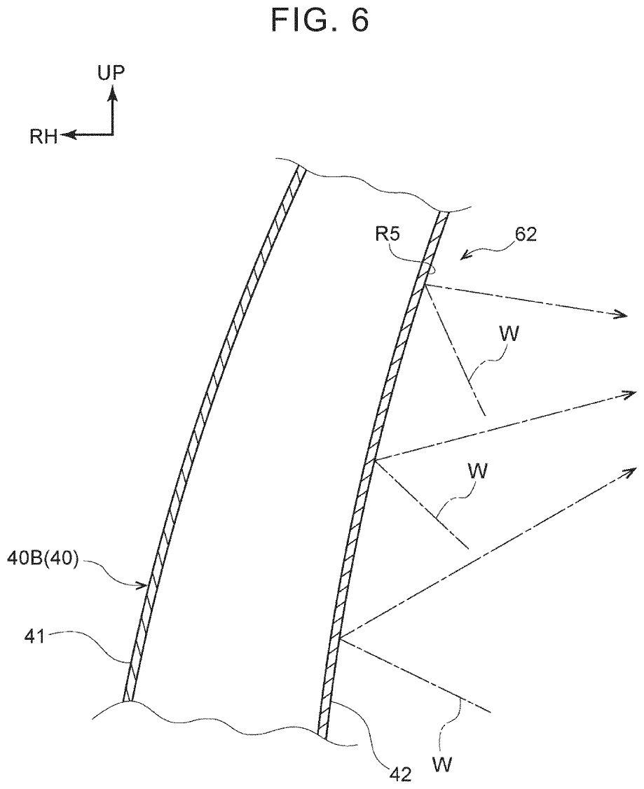

As illustrated in FIG. 6, the pillar inner 42 according to the present embodiment is curved to be gently swelled outward in the vehicle width direction as seen in the vehicle front-rear direction. Thus, it is possible to converge the radio waves W, transmitted from the transmission unit 56 and reflected by a predetermined reflection surface, in a specific direction, when the radio waves W are radiated to a wide range of the pillar inner 42 (reflection unit 62). Consequently, the power supply efficiency can be enhanced by using the reflection unit 62 to supply power to a device that uses much power. It is also possible to deliver the radio waves W to the rear part in the vehicle cabin by reflecting the radio waves W with the upper part of the center pillar 40B, even when the lower part of the center pillar 40B is covered by an occupant with a large physique. In FIG. 6, the radio waves W radiated by a wide area of the reflection unit 62 converge to the reception unit 58 after being reflected by the reflection surface R5. The present disclosure is not limited to the configuration in which the entire side wall portion 42C of the pillar inner 42 is used as a reflection unit, and reflection units 62 formed at a small area may be provided at a plurality of locations along the direction of extension of the center pillar 40B.

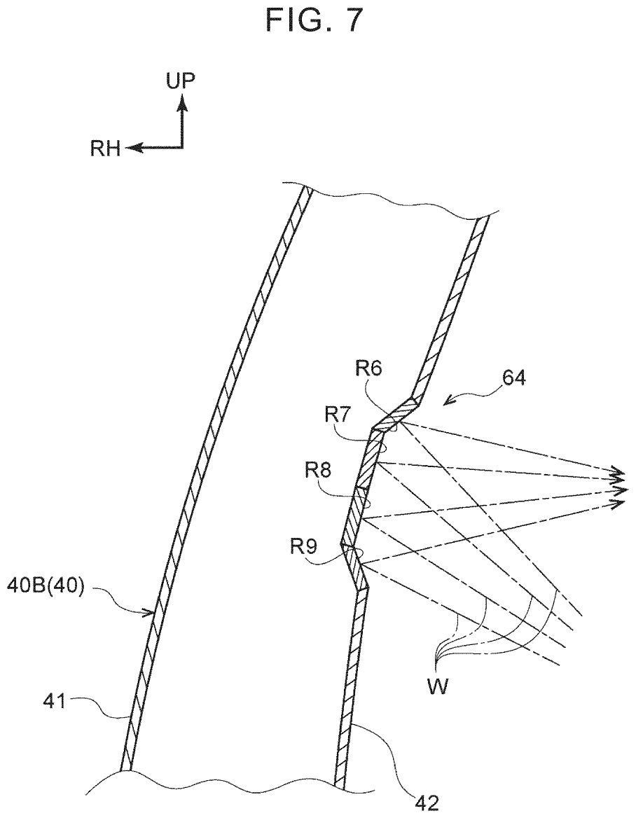

In the present embodiment, the center pillar 40B may be configured to be provided with a reflection unit 64 illustrated in FIG. 7, separately from or in addition to the reflection unit 62 described above. In the reflection unit 64, a plurality of reflection surfaces R6 to R9 directed in different directions are formed on the inside surface of a recessed dent formed in the pillar inner 42. The reflection surfaces (inclined surfaces) R6 to R9 are configured to reflect the radio waves W that have reached the reflection unit 64 so as to converge toward a desired position. Thus, the radio waves W radiated to a wide area of the reflection unit 64 can be converged toward a desired position. In FIG. 7, the radio waves W reflected by the reflection unit 64 converge toward the reception unit 58.

### Reflection Unit Provided on Floor Cross Member 50

FIG. 8 illustrates a cross section of the floor cross member 50, which extends in the vehicle width direction, taken in the vehicle front-rear direction which is orthogonal to the direction in which the floor cross member 50 extends. As illustrated in the drawing, the floor cross member 50 is a beam member that has a cross section in the shape of a hat that opens to downward of the vehicle. Specifically, the floor cross member 50 includes a pair of vertical wall portions 50A that face each other in the vehicle front-rear direction, a transverse wall portion 50B that connects between the respective upper end portions of the vertical wall portions 50A, and horizontal flange portions 50C that extend in directions away from each other from the respective lower end portions of the vertical wall portions 50A. The front and rear flange portions 50C of the floor cross member 50 are joined to the floor panel 52, and both end portions of the floor cross member 50 in the extending direction are connected to the respective rockers.

In the present embodiment, the reflection unit 68 is provided on the transverse wall portion 50B which constitutes a surface of the floor cross member 50 on the inner side of the vehicle cabin. The reflection unit 68 includes a plurality of reflection surfaces R10 to R12 formed on the inside surface of a recessed dent formed in the transverse wall portion 50B, and is formed integrally with the floor cross member 50. The reflection unit 68 according to the present embodiment is a dent in a generally trapezoidal shape including three reflection surfaces R10 to R12, by way of example, and includes a concave ridge line S3 that is concave downward of the vehicle in a cross section taken in the vehicle front-rear direction which is orthogonal to the direction of extension of the floor cross member 50. As a result, the second moment of area of the floor cross member 50 is increased, which contributes to improving the flexural rigidity of the floor cross member 50.

The reflection surfaces R10 to R12 of the reflection unit 68 are directed to different directions, and the radio waves W reflected by the reflection unit 68 can be diffused in a plurality of (three) directions. For example, the reflection surface R10 reflects the radio waves W transmitted from the transmission unit 56 toward the foot light (not illustrated) provided at the lower part of the seat 20. The reflection surface R11 reflects the radio waves W transmitted from the transmission unit 56 toward the height of a hand of a passenger seated in the seat 20. The reflection surface R12 reflects the radio waves W toward the roof cross member 30 directly thereabove. In this manner, the radio waves W transmitted from the transmission unit 56 can be diffused in a predetermined region at the rear part in the vehicle cabin when the radio waves W are radiated to a wide area of the reflection unit 68.

When the transmitted radio waves W are highly directional, the radio waves W can be reflected in a predetermined direction by selecting a predetermined reflection surface(s) from the plurality of reflection surfaces. The reflection unit 68 configured as described above may be formed as a recessed reflection unit in which the transverse wall portion 50B of the floor cross member 50 is curved downward of the vehicle and which extends in the vehicle width direction. Alternatively, the reflection units 68 may be formed at a plurality of locations along the direction of extension of the floor cross member 50.

### Hardware Configuration of Control Unit

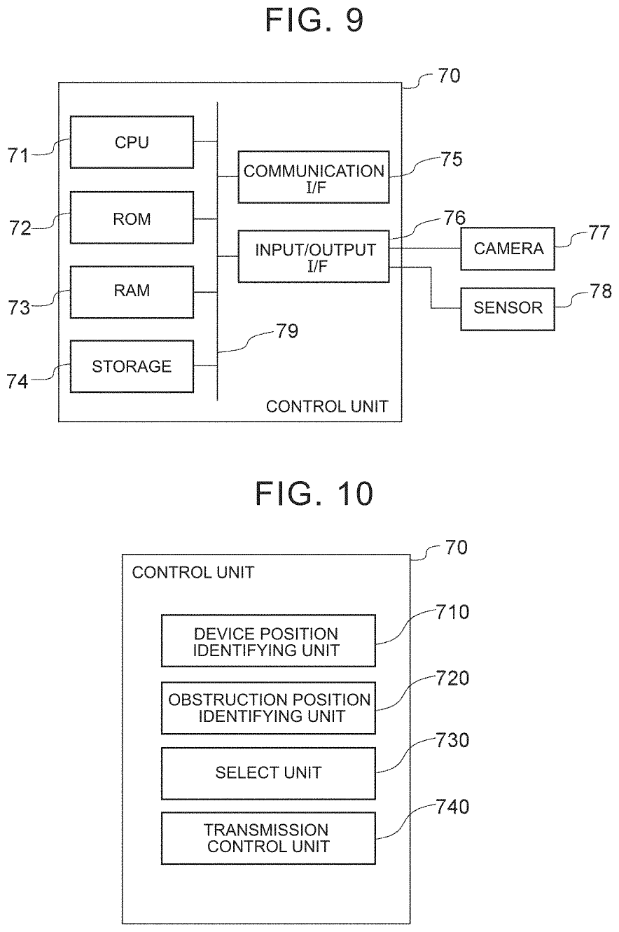

As discussed above, the vehicle 10 according to the present embodiment includes the control unit 70 which controls radio waves transmitted from the transmission unit 56. The control unit 70 is an electronic control unit (ECU) mounted on the vehicle, by way of example. FIG. 9 is a block diagram illustrating the hardware configuration of the control unit 70. The control unit 70 is configured to include a central processing unit (CPU: processor) 71, a read-only memory (ROM) 72, a random access memory (RAM) 73, a storage 74, a communication interface 75, and an input/output interface 76. The components are connected via a bus 79 so as to be mutually communicable.

The CPU 71 is a central arithmetic processing unit, and executes various programs and controls various units. That is, the CPU 71 reads a program from the ROM 72 or the storage 74, and executes the program using the RAM 73 as a work area. The CPU 71 controls the components described above and performs various computation processes in accordance with the programs stored in the ROM 72 or the storage 74.

The ROM 72 stores various programs and various data. The RAM 73 temporarily stores a program or data as a work area. The storage 74 is composed of a hard disk drive (HDD) or a solid state drive (SSD), and stores various programs including an operating system and various data. In the present embodiment, the ROM 72 or the storage 74 stores programs for performing display processes, various data, etc.

The communication interface 75 is an interface for the control unit 70 to communicate with the transmission unit 56 and the reception unit 58 which are provided in the vehicle cabin, a server (not illustrated), and other devices, and uses a standard such as Ethernet (registered trademark), long-term evolution (LTE), fiber-distributed data interface (FDDI), and Wi-Fi (registered trademark).

A camera 77 that shoots the vehicle cabin and a sensor 78 that detects the presence of an occupant in the vehicle cabin are connected to the input/output interface 76. The sensor 78 includes at least one of a pressure sensor for the seat 16, 18, 20 provided in the vehicle cabin, a buckle sensor for a seatbelt device, and a seatbelt sensor provided at a retractor for a seatbelt to detect the amount by which a webbing is pulled out, for example.

### Functional Configuration of Control Unit 70

The control unit 70 implements various functions using the hardware resources described above. The functional configuration implemented by the control unit 70 will be described with reference to FIG. 10.

As illustrated in FIG. 10, the control unit 70 is configured to include, as functional components, a device position identifying unit 710, an obstruction position identifying unit 720, a select unit 730, and a transmission control unit 740. The functional components are implemented by the CPU 71 reading a program stored in the ROM 72 or the storage 74 and executing the program.

The device position identifying unit 710 identifies the positions of devices provided in advance in the vehicle cabin and devices brought into the vehicle cabin by occupants. The device position identifying unit 710 identifies the positions of electrical components, such as the seat reclining device, provided in advance in the vehicle cabin based on vehicle information stored in advance. The device position identifying unit 710 also identifies the positions of devices, such as a smartphone and a tablet, brought into the vehicle cabin by occupants based on an image obtained by the camera 77. Alternatively, the device position identifying unit 710 may identify the positions of devices such as a smartphone and a tablet based on position information provided from the devices.

The obstruction position identifying unit 720 identifies the position of an obstruction that obstructs propagation of radio waves transmitted from the transmission unit 56. Specifically, the obstruction position identifying unit 720 identifies the positions of obstructions, the obstructions being frames etc. made of metal and provided in advance in the vehicle cabin and occupants in the vehicle cabin. The positions of the frames made of metal and provided in advance in the vehicle cabin are identified based on the vehicle information stored in advance. The positions of the occupants in the vehicle cabin are identified by analyzing the image obtained by the camera 77 and based on the results of the detection by the sensor 78.

The select unit 730 has a function of selecting reflection unit(s) for the transmitted radio waves from the plurality of reflection units 60, 62, 64, 68 provided in the vehicle cabin. Specifically, the select unit 730 calculates a transmission path through which a device to be supplied with power can be reached while avoiding the obstructions based on the position information identified by the device position identifying unit 710 and the obstruction position identifying unit 720, and selects reflection unit(s) that reflects radio waves based on the calculated path.

The transmission control unit 740 has a function of transmitting radio waves from the transmission unit 56 toward the reflection unit selected by the select unit 730.

### Functions and Effects

Next, the functions and the effects of the present embodiment will be described.

### Transmission Process

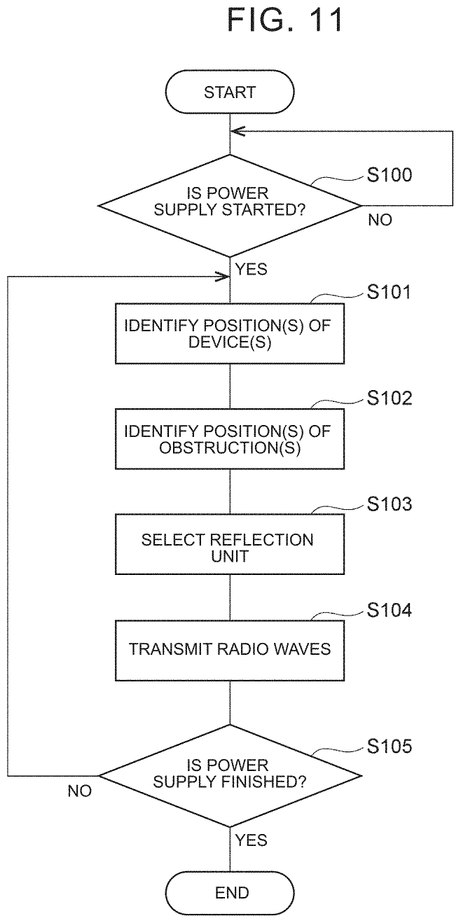

An example of a transmission process for transmitting radio waves toward a selected reflection surface will be described with reference to the flowchart illustrated in FIG. 11. The transmission process is executed by the CPU 71 reading a program from the ROM 72 or the storage 74, developing the program in the RAM 73, and executing the program.

As illustrated in FIG. 11, the CPU 71 determines in step S100 whether power supply is started. The determination in step S100 may be made in accordance with whether a power supply mode for a predetermined device is activated by an operation by an occupant, for example. When it is determined that the power supply mode for the predetermined device is activated, determinations in the following steps are made with the predetermined device determined as a device to be supplied with power in the following steps.

Alternatively, the determination in step S100 may be made in accordance with whether an operation instruction for a device in the vehicle cabin is detected. Alternatively, for a device needed in accompaniment to an action by an occupant, the determination to start power supply may be made with the device determined as a device to be supplied with power when an action by the occupant is detected based on information from the camera 77 or the sensor 78, for example. By way of example, it may be determined to start power supply with a foot light or a ceiling light determined as a device to be supplied with power when a side door open/close sensor detects that the door has been opened, that is, when it is detected that the door is opened by an occupant inside the vehicle or a person outside the vehicle.

When it is determined that power supply is started, the CPU 71 proceeds to step S101. When it is determined that power supply is not started, the CPU 71 returns to the process in step S100.

In step S101, the CPU 71 identifies the positions of devices in the vehicle cabin. Specifically, the CPU 71 identifies the position of a device mounted in advance in the vehicle cabin and the position of a device brought into the vehicle cabin by an occupant based on the function of the device position identifying unit 710.

Subsequently, the CPU 71 identifies the positions of obstructions that obstruct propagation of radio waves in the vehicle cabin in step S102. Specifically, the CPU 71 identifies the position of a seat frame etc. made of metal and mounted in advance in the vehicle cabin and the position of an occupant in the vehicle based on the function of the obstruction position identifying unit 720.

Next, the CPU 71 selects reflection unit(s) that reflect(s) radio waves toward a device to be supplied with power in step S103. Specifically, the CPU 71 calculates a transmission path through which the device to be supplied with power is reached while avoiding the obstructions and selects reflection unit(s) that can reflect radio waves from the plurality of reflection units 60, 62, 64, 68 based on the calculated path, based on the function of the select unit 730.

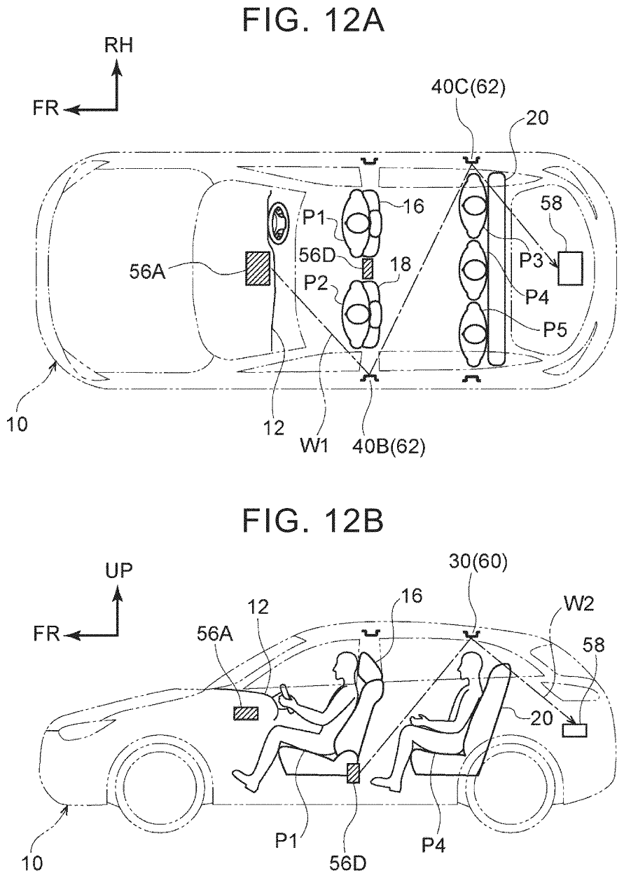

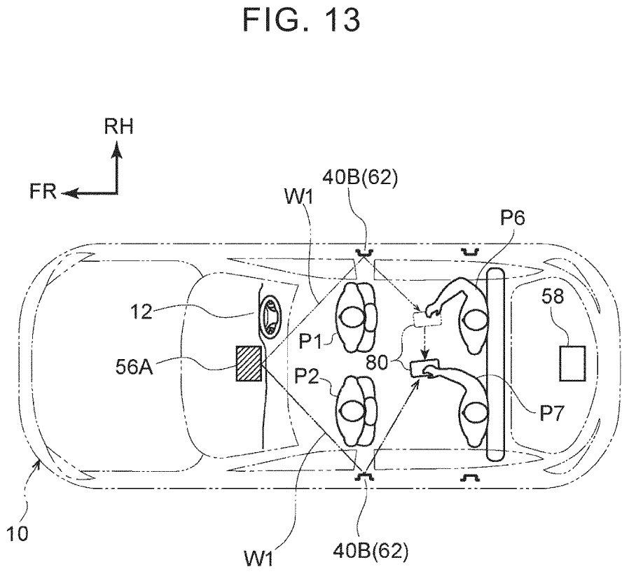

Examples of the transmission path calculated by the select unit 730 will be described with reference to FIGS. 12A, 12B, and 13. In FIGS. 12A and 12B, transmission paths through which radio waves are delivered from the transmission units 56A, 56D provided in the vehicle cabin to the reception unit 58 are indicated respectively by the alternate long and short dash lines by way of examples. In the drawings, in the vehicle cabin of the vehicle 10, a driver P1 is seated in the seat 16 which is the driver's seat, and a passenger P2 is seated in the seat 18 which is the front passenger seat. Passengers P3 to P5 are seated in the three-seater seat 20.

For the transmission path illustrated in FIG. 12A, a radio wave W1 transmitted from the transmission unit 56A reaches the reception unit 58 after being reflected by the reflection unit 62 on the center pillar 40B on the left side of the vehicle and the reflection unit 62 on the rear pillar 40C on the right side of the vehicle.

When the passenger P2 in the front passenger seat is seated while leaning on the side door, for example, the select unit 730 determines that the obstruction cannot be avoided with the use of the reflection unit 62 on the center pillar 40B on the left side of the vehicle since the passenger obstructs the path between the transmission unit 56A and the center pillar 40B. Thus, in this case, the select unit 730 can calculate a transmission path through which the radio wave W1 is propagated to the reception unit 58 after being reflected by the reflection unit 62 on the center pillar 40B on the right side of the vehicle and the reflection unit 62 on the rear pillar 40C on the left side of the vehicle.

In FIG. 12B, on the other hand, an example of a transmission path through which a radio wave W2 transmitted from the transmission unit 56D and to be received by the reception unit 58 is indicated by the alternate long and short dash line. As illustrated in the drawing, the radio wave W2 cannot be delivered to the reception unit 58 through a path that linearly connects between the transmission unit 56D and the reception unit 58 because of interference with the passenger P4 seated at the middle of the seat 20 and the seat frame of the seat 20. Thus, the select unit 730 can calculate a transmission path through which the radio wave W2 is propagated to the reception unit 58 after being reflected by the reflection unit 60 on the roof cross member 30 directly above the seat 20.

FIG. 13 illustrates a transmission path through which a radio wave W1 transmitted from the transmission unit 56A is to be received by a device 80 that is used by a passenger in the vehicle cabin. FIG. 13 illustrates a situation in which the position of the device 80 has been moved from the passenger P6 seated on the right side of the seat 20 of the vehicle 10 to the passenger P7 seated on the left side of the seat 20. First, the radio wave W1 cannot be delivered to the device 80 through a path that linearly connects between the transmission unit 56A and the passenger P6 seated on the right side of the seat 20 because of interference with the driver P1 seated in the seat 16 which is the driver's seat and the seat frame of the seat 16. Thus, when the passenger P6 is using the device 80, the select unit 730 can calculate a transmission path through which the radio wave W1 reaches the device 80 after being reflected by the reflection unit 62 on the center pillar 40B on the right side of the vehicle. After that, when the device 80 is passed from the passenger P6 on the right side of the vehicle to the passenger P7 on the left side of the vehicle, the select unit 730 changes the transmission path, and calculates a path through which the radio wave W1 reaches the device 80 after being reflected by the reflection unit 62 on the center pillar 40B on the left side of the vehicle.

In this manner, the CPU 71 can set a plurality of paths in accordance with the position of the device to be supplied with power and the positions of the obstructions. In Step S104, the transmission unit transmits the radio wave.

In the following step S105, the CPU 71 determines whether power supply is finished. The determination in step S105 may be made in accordance with whether the power supply mode for the predetermined device has been finished by an operation by an occupant, or may be made in accordance with whether it is detected that operation of a device such as an electrical component in the vehicle cabin has been finished. Alternatively, power supply may be finished when a device not needed in accompaniment to an action by an occupant is assumed.

The CPU 71 ends the process when it is determined that power supply is finished. When it is determined that power supply is not finished, the CPU 71 returns to step S101 to repeat the process.

In the vehicle 10 according to the present embodiment, as described above, the reflection unit 60, 62, 64, 68 is provided on a skeleton member, which is made of metal, of the vehicle 10, and the skeleton member is covered from the inner side of the vehicle cabin by an interior member made of a material that allows passage of radio waves. Therefore, the existing skeleton member can be used as a reflection surface for radio waves, and therefore power can be supplied through the radio waves without providing a reflection surface on a separate member. In addition, the reflection unit 60, 62, 64, 68 can be provided without being exposed in the vehicle cabin because of the interior member, and therefore power can be supplied to the device 80 and the reception unit 58 in the vehicle cabin while maintaining an aesthetic appearance in the vehicle cabin.

Specifically, in the present embodiment, the reflection unit 60 is provided on a surface of the roof cross member 30, which reinforces the roof panel 22, on the inner side of the vehicle cabin, and therefore the reflection unit 60 can be covered by the roof head lining 32.

In the present embodiment, the reflection unit 62 is provided on a surface of the pillar 40, which extends in the vehicle up-down direction, on the inner side of the vehicle cabin, and therefore the reflection unit 62 can be covered by the pillar garnish 43.

In the present embodiment, the reflection unit 68 is provided on a surface of the floor cross member 50, which reinforces the floor panel 52, on the inner side of the vehicle cabin, and therefore the reflection unit 68 can be covered by a floor carpet.

The vehicle 10 according to the present embodiment includes the control unit 70 which controls radio waves transmitted from the transmission unit 56. The control unit 70 selects the reflection unit(s) for radio waves from the plurality of reflection units 60, 62, 64, 68. Consequently, a plurality of paths can be set to propagate radio waves to a desired position, and therefore radio waves can be effectively reflected toward the device to be supplied with power.

In the present embodiment, the control unit 70 includes a function of identifying the position of a device in the vehicle cabin, and selects reflection unit(s) that can reflect radio waves toward the position identified by the function. Consequently, it is possible to select the path for the radio waves in accordance with the position of the device in the vehicle cabin, and to efficiently reflect the radio waves toward the predetermined device.

In the present embodiment, the control unit 70 includes a function of identifying the position of an obstruction that obstructs propagation of radio waves, and selects a reflection unit that can propagate radio waves while avoiding the position identified by the function. Consequently, it is possible to select the transmission path for the radio waves in accordance with the position of an obstruction such as the occupant P, the seat 16, 18, 20, etc., and to efficiently reflect the radio waves toward the predetermined device.

In the present embodiment, the reflection unit 60, 62, 64, 68 which is provided on the roof cross member 30, the pillar 40, and the floor cross member 50 includes the recessed or protruding ridge line S1 to S3 in a cross section taken in a direction that is orthogonal to the extending direction. Consequently, the second moment of area of the skeleton member increases, which contributes to improving flexural rigidity. In particular, the shock resistance of the vehicle 10 against a lateral collision can be enhanced when the reflection unit 60, 68 of the roof cross member 30 and the floor cross member 50 includes the ridge line S1, S3.

In the present embodiment, the reception unit 58 is provided in the vehicle cabin, and receives radio waves transmitted from the transmission unit 56. The reception unit 58 is connected to a device, such as an electrical component, in the vehicle cabin, and can supply power to the connected device by receiving radio waves reflected by the reflection unit. Consequently, it is possible to shorten wire harnesses connected to electrical components in the vehicle cabin, and to reduce the total number of required wire harnesses, compared to the conventional structure in which an in-vehicle battery and the electrical components are connected to each other by wire harnesses. As a result, the wire harnesses required for wiring of the electrical components can be reduced to about one-fifth of those in the conventional vehicle. As a result, the wiring space can be reduced, which improves the degree of freedom in designing the space in the vehicle cabin and increases the range of movement of the electrical components.

It is assumed to be difficult to directly supply power to an electrical component fixed to, or disposed in the vicinity of, a large metal member provided in the vehicle cabin, such as a seat frame, since the surrounding metal member reflects radio waves. By supplying power via the reception unit 58, however, power can be supplied efficiently without interference by the surrounding metal member.

### Supplementary Description

While the vehicle according to the embodiment has been described above, the vehicle may be implemented in a variety of aspects without departing from the scope and spirit of the present disclosure. For example, while the reflection unit 60 is provided on the roof cross member 30 which reinforces the roof panel 22 in the above embodiment, the present disclosure is not limited thereto. For example, a reflection unit 60 that is similar to that on the roof cross member 30 may be provided on the roof side rail 24, the front header 26, or the rear header 28. A reflection unit 62 that is similar to that on the center pillar 40B may be provided on the front pillar 40A or the rear pillar 40C.

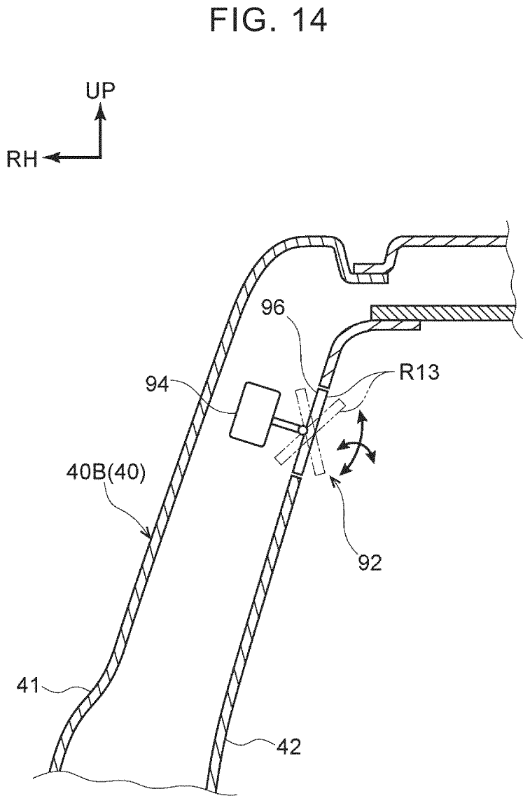

While the control unit 70 according to the above embodiment is configured to change the transmission path for the radio waves W by changing the direction of radio waves transmitted from the transmission unit 56 to a desired direction, the present disclosure is not limited thereto. For example, when a reflection unit 92 according to a modification of the present embodiment illustrated in FIG. 14 is applied to the center pillar 40B, the tilt of a reflection surface R13 of the reflection unit 60 may be changed to a desired direction based on an instruction from the control unit 70. The reflection unit 92 illustrated in FIG. 14 includes a movable portion 96 provided in a part of the pillar inner 42 of the center pillar 40B, and the tilt of the reflection surface R13 of the movable portion 96 on the inner side of the vehicle cabin changes by moving the movable portion 96 through actuation of an actuator 94. The reflection unit 92 can deliver the reflected radio waves W in a desired direction by adjusting the tilt of the reflection surface R13 using the actuator 94. With the configuration according to the modification, radio waves can be delivered with pinpoint accuracy to a small device such as a smartphone.

While power is directly supplied through radio waves to a device, such as a smartphone, brought into the vehicle cabin by an occupant in the above embodiment, the present disclosure is not limited thereto. For example, if electrical components provided in the vehicle cabin include respective reception units, power can be directly supplied through radio waves to the individual electrical components.

While the reflection unit 60, 62, 64, 68 is provided with a plurality of reflection surfaces and configured to reflect radio waves in a plurality of directions in the above embodiment, the present disclosure is not limited thereto. The reflection unit may be formed to have a continuous, smoothly curved surface and configured to reflect radio waves in a plurality of directions.

While a reflection unit with a recessed or protruding ridge line is formed on a surface of a skeleton member in the above embodiment, the present disclosure is not limited thereto. A planar portion on the surface of the skeleton member may be used as a reflection unit.

While a reflection unit is provided integrally with a skeleton member in the above embodiment, the present disclosure is not limited thereto. A reflection unit that is not provided integrally with the skeleton member may be applied. For example, a reflection unit made of metal and formed separately from a skeleton member may be fixed to the skeleton member, and covered by an interior member from the inner side of the vehicle cabin.

The transmission process, which is executed by the CPU 71 reading software (program) in the above embodiment, may be executed by various processors other than the CPU 71. Examples of the processor in this case include a programmable logic device (PLD) that has circuitry that is changeable after being manufactured, such as a field-programmable gate array (FPGA), and a dedicated electric circuit which is a processor that has circuitry exclusively designed to execute a specific process, such as an application specific integrated circuit (ASIC). The transmission process may be executed by one of the various processors, or may be executed by a combination of two or more processors of the same type or different types (e.g. a plurality of FPGAs, a combination of a CPU and an FPGA, etc.). The hardware structure of the various processors is, to be more specific, an electric circuit formed by combining circuit elements such as semiconductor elements.

While various data are stored in the storage 74 in the above embodiment, the present disclosure is not limited thereto. For example, a storage medium such as a Compact Disc (CD), a Digital Versatile Disc (DVD), and a Universal Serial Bus (USB) memory may be used as a storage unit. In this case, various programs, data, etc. are stored in the storage medium.

What is claimed is:

1. A vehicle comprising:
a transmission unit provided in a vehicle cabin to transmit a radio wave for supplying power to a device in the vehicle cabin; and
a reflection unit that reflects the radio wave transmitted from the transmission unit toward the device, wherein:
the reflection unit is provided on a skeleton member made of metal; and
the skeleton member including the reflection unit is covered from a vehicle cabin inner side by an interior member made of a material that allows passage of the radio wave.

2. The vehicle according to claim 1, wherein:
the skeleton member is a pillar that extends in a vehicle up-down direction; and
the reflection unit is provided on a surface of the pillar on the vehicle cabin inner side.

3. The vehicle according to claim 1, wherein:
the skeleton member is a roof cross member that extends in a vehicle width direction to reinforce a roof panel; and
the reflection unit is provided on a surface of the roof cross member on the vehicle cabin inner side.

4. The vehicle according to claim 1, wherein:
the skeleton member is a floor cross member that extends in a vehicle width direction to reinforce a floor panel; and
the reflection unit is provided on a surface of the floor cross member on the vehicle cabin inner side.

5. The vehicle according to claim 1, further comprising a control unit that controls the radio wave transmitted from the transmission unit, wherein:
a plurality of reflection units is provided as the reflection unit; and
the control unit includes a select unit that selects at least one reflection unit that reflects the radio wave from the plurality of reflection units.

6. The vehicle according to claim 5, wherein:
the control unit further includes a device position identifying unit that identifies a position of the device in the vehicle cabin; and
the select unit selects, based on the position identified by the device position identifying unit, at least one reflection unit that is able to reflect the radio wave toward the device installed at the position, from the plurality of reflection units.

7. The vehicle according to claim 5, wherein:
the control unit further includes an obstruction position identifying unit that identifies a position of an obstruction that obstructs propagation of the radio wave in the vehicle cabin; and
the select unit selects, based on the position identified by the obstruction position identifying unit, at least one reflection unit that is able to propagate the radio wave avoiding the obstruction that is present at the position, from the plurality of reflection units.

8. The vehicle according to claim 1, wherein the reflection unit includes a recessed or protruding ridge line in a cross section taken in a direction that is orthogonal to a direction in which the skeleton member extends.

9. The vehicle according to claim 1, further comprising a reception unit provided in the vehicle cabin and connected to the device, the reception unit receiving the radio wave transmitted from the transmission unit, wherein the reflection unit reflects the radio wave transmitted from the transmission unit toward the reception unit, and the reception unit supplies power to the device using the radio wave which the reception unit receives.
